(19) United States
(12) Patent Application Publication
(10) Pub. No.: US 2019/0103047 A1
(43) Pub. Date: Apr. 4, 2019

(54) DISPLAY DEVICE AND METHOD TO GENERATE COLOR IMAGE

(71) Applicant: Chul CHUNG, Seoul (KR)

(72) Inventor: Chul CHUNG, Seoul (KR)

(21) Appl. No.: 16/134,980

(22) Filed: Sep. 19, 2018

Related U.S. Application Data
(60) Provisional application No. 62/565,131, filed on Sep. 29, 2017.

(51) Int. Cl. G09G 3/20; G09G 3/3233

(52) U.S. Cl. CPC G09G 3/2003; G09G 3/3233; G09G 2320/0626; G09G 2320/0242; G09G 2320/066; G09G 2340/0457

(57) ABSTRACT

A display device includes a color plate and a shutter device. The color plate includes color pixels configured to emit color lights included in a first color image. The shutter device is disposed on the color plate to receive the color lights of the first color image and includes shutter pixels adjusting the color lights of the first color image to output a second color image. The shutter device contains a first number of the shutter pixels in a unit area and the color plate contains a second number of the color pixels in the unit area, the first number being greater than the second number.

### CROSS-REFERENCE TO RELATED APPLICATION

This application claims priority from and the benefit of U.S. Provisional Patent Application No. 62/565,131, filed on Sep. 29, 2017, which is hereby incorporated by reference for all purposes as if fully set forth herein.

### BACKGROUND

### Field

The invention relates generally to display devices and methods to generate color images, and more particularly to display devices and methods capable of improving resolution and color rendition with high brightness and contrast.

### Discussion of the Background

A Liquid crystal display (LCD) generally includes pixels filled with liquid crystals, and a thin film transistor (TFT) backplane to switch each individual pixel on or off. Since the liquid crystals do not produce light by themselves, they need backlight illumination from behind or side of the display panel. The backlight unit may include one or more light-emitting diodes (LED) to provide the liquid crystals with the light. In this manner, the liquid crystal display may have relatively low brightness and contrast.

An organic light-emitting diode (OLED) display generally includes a layer of an organic compound in a pixel area, and a thin film transistor (TFT) backplane to switch each individual pixel on or off. An organic light-emitting diode display works without a backlight and can display deep black levels. The organic compound layer is sensitive to air and moisture, which can lead to degradation of the display. OLED displays are typically encapsulated with a rigid glass cover to protect the organic compound from air and moisture.

A light-emitting diode display is considered more as replacement for light sources for flat panel displays, such as organic light-emitting diode display and liquid crystal display. For example, light-emitting diodes are found in digital signage, mobile electronic displays, and televisions. The light-emitting diode display may include a plurality of pixels each having one or more light-emitting diodes, and the plurality of pixels may be driven to express various color lights. For example, the light-emitting diode display may include a micro LED display. The light-emitting diode display may have relatively high brightness and contrast, but may be expensive to manufacture with higher resolution. For example, the light-emitting diode display needs to include more light-emitting diodes for increasing a resolution, and the manufacturing cost may increase as the number of light-emitting diodes increases.

The above information disclosed in this Background section is only for enhancement of understanding of the background of the inventive concept, and, therefore, it may contain information that does not form the prior art that is already known to a person of ordinary skill in the art.

### SUMMARY

Exemplary embodiments of the invention provide a display device and a method suitable for improving a resolution with high brightness and contrast. For example, the display device includes a color plate having relatively high brightness and contrast, and a shutter device having a higher resolution than the color plate.

According to an exemplary embodiment constructed according to the principles of the invention, a display device includes: a color plate including color pixels configured to emit color lights included in a first color image; and a shutter device disposed on the color plate to receive the color lights of the first color image and including shutter pixels, wherein the shutter device is configured to adjust the color lights of the first color image to output a second color image. The shutter device contains a first number of the shutter pixels in a unit area and the color plate contains a second number of the color pixels in the unit area, the first number being greater than the second number.

The shutter pixels may have a resolution higher than a resolution of the color pixels.

The color pixels may include sub color pixels each emitting one of a plurality of colors.

In a unit area, the number of shutter pixels may be equal to or greater than the number of sub color pixels.

At least some of boundaries between the shutter pixels may be positioned along boundaries between the sub color pixels.

The at least some of boundaries between the shutter pixels may overlap the sub color pixels.

Each of at least some of the shutter pixels may overlap two or more sub color pixels.

The display device may further include a first peripheral controller configured to control the sub color pixels to emit the color lights of the first color image based on first image data having a resolution of the color pixels. In an embodiment, the first peripheral controller is configured to receive as input image data the first image data having a resolution of the color pixels, and controls the sub color pixels to emit the color lights of the first color image based on first image data received.

In an embodiment, the first peripheral controller is configured to receive as input image data third image data having a third resolution higher than the resolution of the color pixels. In this embodiment, the first peripheral controller performs chroma subsampling on the third image data to generate the first image data, then controls the sub color pixels to emit the color lights of the first color image based on first image data generated.

The display device may further include a second peripheral controller configured to control the shutter pixels to adjust the luminance of the first color image based on second image data having the resolution of the shutter pixels.

The display device may further include at least one diffusing layer disposed between the color plate and the shutter device and configured to diffuse and pass the color lights of the first color image.

The color pixels may include sub color pixels each emitting one of a plurality of colors; and the color plate may include a substrate and light-emitting diodes arranged on the substrate. In various embodiments, each of the sub color pixels includes at least one of the light-emitting diodes.

The color plate may include a micro-LED display, and the shutter device may include a liquid-crystal display.

According to an exemplary embodiment according to the principles of the invention, a method of generating a color image includes steps of: receiving input image data; processing the input image data to generate first image data including color information of the input image data and to generate second image data including luminance information of the input image data, the first image data having a first resolution and the second image data having a second resolution higher than the first resolution; generating color lights to provide a first color image based on the first image data; and adjusting luminance of the color lights of the first color image to output a second color image based on the second image data. The step of generating may include generating the color lights of the first color image from color pixels; and the step of adjusting may include adjusting the luminance of the color lights of the first color image at shutter pixels overlapping the color pixels to receive the color lights of the first color image. The first resolution may correspond to the number of the color pixels and the second resolution may correspond to the number of the shutter pixels.

The input image data may have a third resolution higher than the first resolution. In this embodiment, the step of processing may include performing chroma subsampling on the input image data to generate the first image data.

The method may further include a step of optically compensating the first color image before adjusting the luminance of the first color image.

The step of optically compensating may include diffusing the color lights of the first color image before adjusting the luminance the first color image. In this embodiment, the adjusting step adjusts the luminance of the color lights of the optically compensated first color image at shutter pixels overlapping the color pixels, and may include adjusting the luminance of the color lights of the optically compensated first color image at one or more shutter pixels adjacent the shutter pixels overlapping the color pixels.

Additional aspects will be set forth in the detailed description which follows, and, in part, will be apparent from the disclosure, or may be learned by practice of the inventive concept.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a perspective view of an exemplary embodiment of a hybrid display device constructed according to the principles of the invention.

FIG. 2 is a block diagram of an exemplary embodiment of a peripheral circuit associated with a color plate and a shutter device of FIG. 1.

FIG. 3 is a perspective view of an exemplary structure suitable for implementing exemplary embodiments of the color plate of FIG. 1.

FIG. 4 is a perspective view of a portion of an exemplary embodiment of the hybrid display device of FIG. 1.

FIG. 5 is a perspective view of a portion of another exemplary embodiment of a hybrid display device.

FIG. 6 is a perspective view of a portion of still another exemplary embodiment of a hybrid display device.

FIG. 7 is a plan view of a portion of yet still another exemplary embodiment of a hybrid display device.

FIG. 8 is a perspective view of another exemplary embodiment of a hybrid display device constructed according to the principles of the invention.

FIG. 9 is a flowchart of a method of generating a color image according to the principles of the invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

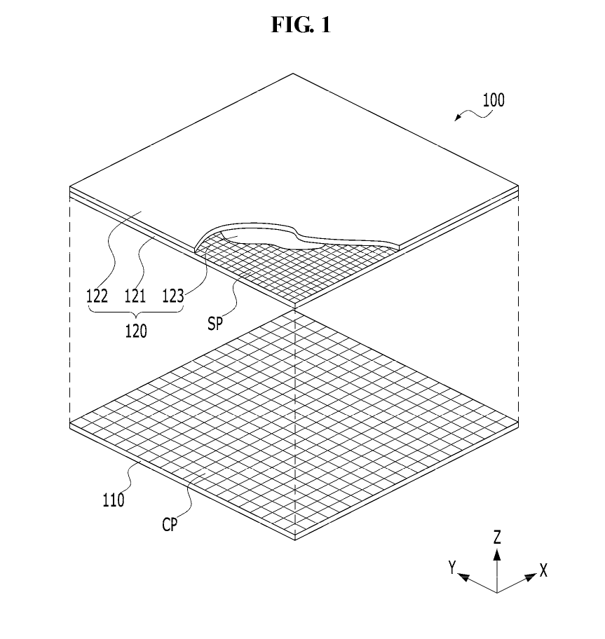

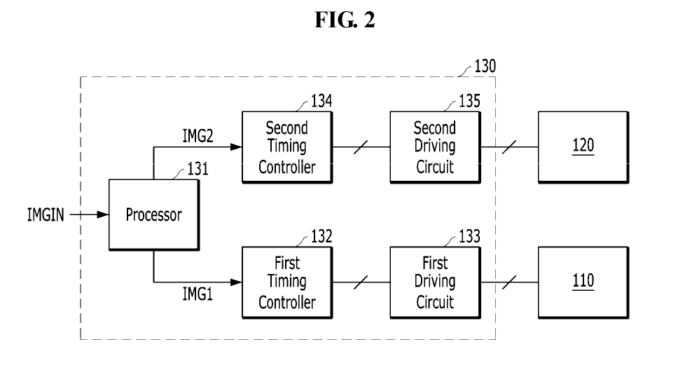

FIG. 1 is a perspective view of an exemplary embodiment of a hybrid display device constructed according to the principles of the invention. FIG. 2 is a block diagram of an exemplary embodiment of a peripheral circuit associated with a color plate and a shutter device of FIG. 1.

Referring to FIG. 1, the hybrid display device 100 includes a color plate 110 and a shutter device 120 facing the color plate 100. The color plate 110 includes color pixels CP that are arranged in an upper surface direction of the color plate 100. For example, the color pixels CP may be arranged in a first direction X and a second direction Y intersecting the first direction X as shown in FIG. 1. However, exemplary embodiments are not limited thereto. The arrangement of the color pixels CP may vary, if necessary.

Each of the color pixels CP may include sub color pixels each emitting one of color lights, such as red, green, blue, yellow, white, etc., such that each of the color pixels CP expresses various colors. The sub color pixel may be a self-emissive display element. For example, the sub color pixel may include at least one semiconductor-based Light-Emitting Diode (LED) that emits a certain color light to the shutter device 120.

The hybrid display device 100 may further include a peripheral circuit controlling the color pixels CP. The peripheral circuit may receive input image data having a resolution corresponding to the color pixels CP, and control the sub color pixels of the color pixels CP to generate the color image. Referring to FIG. 2, the peripheral circuit 130 may include a processor 131, a first timing controller 132, and a first driving circuit 133. The processor 131 provides the first timing controller 132 with first image data IMG1 based on input image data IMGIN received from, for example, an external device. The processor 131 may process the input image data IMGIN to generate the first image data IMG1 having a resolution of the color pixels CP when the input image data IMGIN is not matched with the resolution of the color pixels CP. For example, the processor 131 may receive input image data IMGIN having a resolution higher than the resolution of the color pixels, and may perform chroma subsampling on the input image data to generate the first image data IMG1 having the resolution of the color pixels CP. In another exemplary embodiment, the processor 131 may receive the input image data IMGIN processed by using the chroma subsampling method to have the resolution of the color pixels CP, and may transfer them to the first timing controller 132 as the first image data IMG1. The first image data IMG1 may include color information of the input image data IMGIN to be displayed at each color pixel.

Regarding the chroma subsampling, U.S. Pat. No. 9,153,017 is hereby incorporated by reference. Chroma subsampling reduces the spatial resolution of color information while retaining the spatial resolution of brightness information. The method of the '017 patent reduces the tendency of chroma subsampling to introduce visually disturbing artifacts, such as in images containing text, striped patterns, checkerboard patterns, computer-rendered graphics, and artificially generated smooth gradients.

The first timing controller 132 outputs data signals to the first driving circuit 133 to control the sub color pixels of the color pixels CP of the color plate 110 depending on the first image data IMG1. The first driving circuit 133 may control the sub color pixels of the color pixels CP via, for example, scan lines and data lines based on the data signals. In this case, the sub color pixels of the color pixels CP may be disposed on a thin-film transistor layer, and the scan lines and the data lines may be included in the thin-film transistor layer.

In an exemplary embodiment, at least one of the processor 131, the first timing controller 132, and the first driving circuit 133 may be directly mounted on the color plate 110 in a form of at least one integrated circuit chip. In an exemplary embodiment, at least one of the processor 131, the first timing controller 132, and the first driving circuit 133 may be mounted on a flexible printed circuit board to be attached to the color plate 110.

In one or more exemplary embodiments, the color plate 110 may be a micro-LED display. As used herein, a micro-LED display includes LED devices each having a maximum width of 1 μm-100 μm, and in some embodiments includes LED devices each having a maximum width of 1 μm-150 μm.

In another exemplary embodiment, the color plate 110 may be an organic light-emitting diode (OLED) display.

Referring back to FIG. 1, the shutter device 120 is disposed over the color plate 110. For example, the color plate 110 and the shutter device 120 may be stacked in a third direction Z. The shutter device 120 receives the color lights emitting from the color plate 110 and control luminance of the color lights to generate color images that viewers can see.

In one or more exemplary embodiments, the shutter device 120 may be a Liquid-Crystal Display (LCD) panel. The shutter device 120 may include a first substrate 121, a second substrate 122, and a liquid crystal layer 123. The first substrate 121 includes shutter pixels SP that are arranged in the upper surface direction of the first substrate 121. For example, the shutter pixels SP may be arranged in the first direction X and the second direction Y. The shutter pixels SP may be arranged in the similar manner to the color pixels CP. However, the arrangement of the shutter pixels SP is not limited thereto. For example, the shutter pixels SP may have a different arrangement from that of the color pixels CP and/or the sub color pixels.

The second substrate 122 is disposed on the first substrate 121. The second substrate 122 may include a common electrode. Alternatively, the common electrode may be disposed in the first substrate 121. The first and second substrates 121 and 122 may be transparent to allow color lights, emitting from the color plate 110, to pass through the shutter device 120 depending on the alignment of the liquid crystal layer 123. The liquid crystal layer 123 is disposed between the first and second substrates 121 and 122.

The shutter pixels SP adjust luminance of the color lights emitting from the color pixels CP. Plural shutter pixels SP may control the luminance of the color light of one color pixel. That is, the shutter pixels SP of the shutter device 120 have a resolution higher than that of the color pixels CP of the color plate 110. This may enable viewers to perceive a final output image as an image of using color pixels having a higher resolution. Accordingly, the shutter pixels SP of the shutter device 120 enables the hybrid display device 100 to implement a higher resolution of the final output image than the color pixels CP, without increasing the number of color pixels CP.

Each of the shutter pixels SP may include one or more sub shutter pixels. In an exemplary embodiment, each of the sub shutter pixels includes a color filter able to convert light to a certain range of wavelengths, such as red, green, blue, yellow, etc., such that the each of the shutter pixels SP expresses various colors. In this manner, the exemplary embodiment may have more sub shutter pixels in a unit area than the sub color pixels. This may also enable the hybrid display device 100 to implement the higher resolution than the sub color pixels and/or color pixels CP.

The peripheral circuit of the hybrid display device 100 may control the shutter pixels SP as well. Referring to FIG. 2, the peripheral circuit 130 may further include a second timing controller 134 and a second driving circuit 135. The processor 131 provides the second timing controller 134 with second image data IMG2 based on the input image data IMGIN. The input image data IMGIN and the second image data IMG2 each may have a resolution of the shutter pixels SP that is higher than the resolution of the color pixels CP. The input image data IMGIN may have a resolution substantially the same as that of the second image data IMG2. The processor 131 may process the input image data IMGIN to generate the second image data IMG2 having luminance information to be expressed at each of shutter pixels SP. The second image data IMG2 may not include color information. In an exemplary embodiment, the processor 131 may include a compensation algorithm to modify the luminance information for each of shutter pixels SP on the basis of the first image data IMG1 so as to compensate differences in brightness between the color pixels CP.

The second timing controller 134 outputs data signals to the second driving circuit 135 to control the shutter pixels SP depending on the second image data IMG2. The second driving circuit 135 may control the shutter pixels SP via, for example scan lines and data lines based on the data signals. In this case, the sub color pixels of the color pixels CP may be disposed on a thin-film transistor layer, and the scan lines and the data lines may be included in the thin-film transistor layer. Due to factors caused by voltages of each shutter pixel and the common electrode, the liquid crystal layer 123 may adjust luminance of the color lights emitting from the sub color pixels of the color pixels CP. Accordingly, the hybrid display device 100 may serve a desired color image.

In an exemplary embodiment, at least one of the processor 131, the second timing controller 134, and the second driving circuit 135 may be directly mounted on the shutter device 120 in a form of at least one integrated circuit chip. In an exemplary embodiment, at least one of the processor 131, the second timing controller 134, and the second driving circuit 135 may be mounted on a flexible printed circuit board to be attached to the shutter device 120.

In one or more exemplary embodiments, the control circuits for the color plate 110 and the control circuits for the shutter device 120, such as the processor 131, the first timing controller 132, the first driving circuit 133, the second timing controller 134, and the second driving circuit 135, may be separately or integrally provided with the hybrid display device 100. For example, the first and second timing controller 132 and 134 are integrated with each other and control each of the first and second driving circuits 133 and 135. In another exemplary embodiment, the control circuits for the color plate 110 and the shutter device 120 may be integrated with each other.

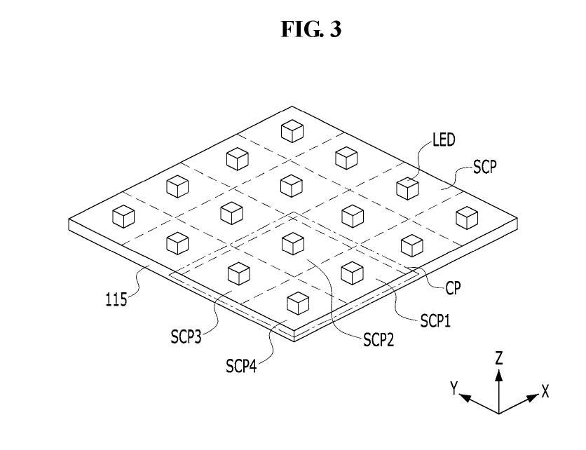

FIG. 3 is a perspective view of an exemplary structure suitable for implementing exemplary embodiments of the color plate of FIG. 1.

Referring to FIG. 3, the color plate 110 may include a substrate 115 and light-emitting diodes LED.

The light-emitting diodes LED may be arranged on the upper surface of the substrate 115, and may emit lights to the shutter device 120. For example, the light emitting-diodes LED may protrude from the substrate 115 in the third direction Z. However, exemplary embodiments of the light-emitting diodes LED are not limited thereto. For example, the light-emitting diodes LED may protrude from the substrate 115 in an opposite direction to the third direction Z and emit lights to the shutter device 120 through the substrate 115 which is transparent. For another example, the light-emitting diodes LED may be buried in the substrate 115 which is transparent.

In one or more exemplary embodiments, the light-emitting diodes LED may emit different color lights, such as red, green, blue, yellow, white, etc. In another exemplary embodiment, the light-emitting diodes LED may emit the same color light having a certain wavelength such as white, ultraviolet ray, or blue light, and may include wavelength conversion layers disposed to pass the same color light emitting from the light-emitting diodes LED. The wavelength conversion layers may convert the same color light into different color lights, such as red, green, blue, yellow, and white.

Since the light emitting from each of the light-emitting diodes LED may spread to a given orientation range that is adjacent to the corresponding light-emitting diode, a region overlapping the light-emitting diode and an adjacent region surrounding the light-emitting diode may be defined as a sub color pixel. As such, each sub color pixel may include a single light-emitting diode. However, exemplary embodiments of the sub color pixel are not limited thereto. The sub color pixel may further include two or more light-emitting diodes. For example, the sub color pixel may include a main light-emitting diode and an additional light-emitting diode. In this manner, the additional light-emitting diode may allow the sub color pixel to provide the light even if the main light-emitting diode does not operate normally. In FIG. 3, the sub color pixels SCP are indicated by dotted line.

The sub color pixels SCP may be grouped and each group may configure a color pixel. As shown in FIG. 3, each of the color pixels CP may include first to fourth sub color pixels SCP1 to SCP4. Two sub color pixels of the first to fourth sub color pixels SCP1 to SCP4 may have the same color, such as green. For example, the first to fourth sub color pixels SCP1 to SCP4 may emit red, green, blue, and green, respectively. However, the configurations of the color pixels CP are not limited thereto. For example, each of the color pixels CP may include three sub color pixels, such as red, green, and blue. For another example, each of the color pixels CP may include red, green, blue, and white.

While the sub color pixels SCP included in one color pixel are shown as having a matrix form in the illustrated embodiment, the arrangement and shapes of the sub color pixels SCP are not limited thereto. For example, all of the sub color pixels included in one color pixel may be arranged in one direction (e.g., the first direction X). For another example, the sub color pixels included in the color pixel may be arranged in a zigzag form.

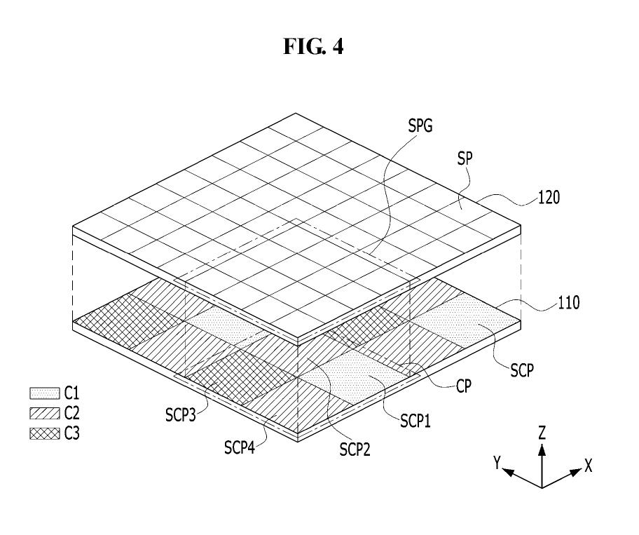

FIG. 4 is a perspective view of a portion of an exemplary embodiment of the hybrid display device of FIG. 1.

Referring to FIG. 4, the color plate 110 includes the color pixels CP and the shutter device 120 includes the shutter pixels SP. The color pixels CP of the color plate 110 have a resolution lower than that of the shutter pixels SP of the shutter device 120. That is, in a unit area, the color plate 110 has less color pixels CP than the shutter pixels SP of the shutter device 120.

Plural shutter pixels SP may overlap one color pixel and may adjust the luminance of the color light emitting from the color pixel. The shutter pixels SP may be disposed on the color pixels CP such that N number of shutter pixels SP may adjust the luminance of the color light emitting from one color pixel, where N is a positive integer equal to or greater than 1. For instance, the color pixels CP may have 2K resolution and the shutter pixels SP may have 8K or more resolution.

Table 1 shows exemplary values of color pixel (SP) resolutions, with shutter pixel (SP) resolutions of 4K and 8K. Table 1 shows that various values of the number N of shutter pixels SP that adjust luminance of the color light emitted from one color pixel CP, where N is an integer greater or equal to 1.

TABLE 1
Color Plate Resolutions and Shutter Device Resolutions

| | | | # Shutter Pixels | | # Shutter Pixels |
|---|---|---|---|---|---|
| | | Shutter Device | (SP) per Color | Shutter Device | (SP) per Color |
| Color Plate | # Color | Resolution | Pixel (CP) | Resolution | Pixel (CP) |
| Resolutions | Pixels (CP) | (4K Display) | (4K Display) | (8K Display) | (8K Display) |
| 320 × 180 | 57.6k | 3840 × 2160 | 12 | 7680 × 4320 | 24 |
| 384 × 216 | 82.9k | 3840 × 2160 | 10 | 7680 × 4320 | 20 |
| 480 × 270 | 129.6k | 3840 × 2160 | 8 | 7680 × 4320 | 16 |
| 640 × 360 | 230.4k | 3840 × 2160 | 6 | 7680 × 4320 | 12 |
| 786 × 432 | 331.8k | 3840 × 2160 | 5 | 7680 × 4320 | 10 |
| 960 × 540 | 518.4k | 3840 × 2160 | 4 | 7680 × 4320 | 8 |
| 1280 × 720 | 921.6k | 3840 × 2160 | 3 | 7680 × 4320 | 6 |
| 1920 × 1080 | 2.073M | 3840 × 2160 | 2 | 7680 × 4320 | 4 |
| 2560 × 1440 | 3.686M | | | 7680 × 4320 | 3 |
| 3840 × 2160 | 8.294M | | | 7680 × 4320 | 2 |

Each of the color pixels CP may include the first to fourth sub color pixels SCP1 to SCP4. The region of the shutter device 120 overlapping one color pixel includes shutter pixels SP equal to or more than the sub color pixels SCP of the color pixel. That is, in a unit area such as a region overlapping one color pixel, the number of the sub color pixels SCP may be equal to or less than that of the shutter pixels SP. For instance, 16 shutter pixels SP may correspond to 4 sub color pixels as shown in FIG. 4. In this case, 4 shutter pixels SP may correspond to one sub color pixel as shown in FIG. 4. However, exemplary embodiments are not limited thereto. For example, 9 shutter pixels SP may correspond to one color pixel that includes 3 or 4 sub color pixels. The shutter pixels SP corresponding to one color pixel may be defined as a shutter pixel group SPG. The shutter pixel groups SSPG may overlap the color pixels CP, respectively, and each of the shutter pixel groups SPG include shutter pixels SP equal to or more than the sub color pixels SCP of a corresponding color pixel.

Each of the color pixels CP in the illustrated embodiment is shown as including first to fourth sub color pixels SCP1 to SCP4 which emit a first color C1, a second color C2, a third color C3, and the second color C2, respectively. The first to third colors C1 to C3 each may vary, depending on configurations and developments of technologies, being one of exemplary combinations, such as red, green, blue, and yellow and/or any other colors. However, exemplary embodiments are not limited thereto. For example, each of the color pixels CP may include three sub color pixels, and the arrangement and shapes of the shutter pixels SP may change accordingly. For instance, the first to third colors C1 to C3 may be red, green, blue, and green, respectively.

The color pixels CP and the shutter pixels SP in the illustrated embodiment are shown as being arranged in the first and second direction X and Y. However, exemplary embodiments of the color pixels CP and the shutter pixels SP are not limited thereto. For example, the color pixels CP and/or the shutter pixels SP may be arranged in a zigzag form. The shapes of the color pixels, the sub color pixels SCP, and the shutter pixels SP may also be different according to exemplary embodiments.

Since the sub color pixels SCP include self-emissive display elements such as light-emitting diodes, the sub color pixels SCP may have relatively high brightness and contrast. However, the sub color pixels SCP may not have to be manufactured with relatively high resolution and degree of integration. On the other hand, the shutter pixels SP such as liquid crystal display pixels may be manufactured with relatively high resolution and degree of integration, but may have relatively low brightness and contrast in case of receiving the same color lights, such as white, emitting from a backlight unit.

According to exemplary embodiments constructed according to the principles of the invention, the hybrid display device 100 includes the color plate 110 which includes the color pixels CP having relatively low resolution and the shutter device 120 which includes the shutter pixels SP having relatively high resolution. The color pixels CP includes sub color pixels SCP and have relatively high brightness and contrast since the sub color pixels SCP include self-emissive display elements such as light-emitting diodes. Given that the human eye has lower acuity for color difference than for luminance difference and some encoding method such as chroma subsampling is used accordingly, even though the color pixels CP has the normal resolution, the shutter pixels SP with a higher resolution may adjust luminance of the color lights emitting from the color pixels CP. This enables viewers to perceive the final output image as images including color pixels having a higher resolution. Thus, the color plate 110 may enable the hybrid display device 100 to output images with the high brightness and contrast, and the shutter device 120 may enable the output images have relatively high resolutions.

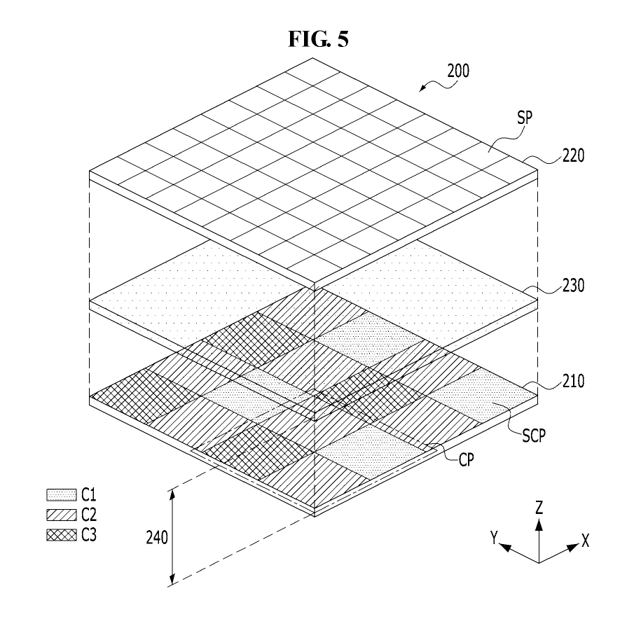

FIG. 5 is a perspective view of a portion of another exemplary embodiment of a hybrid display device.

Referring to FIG. 5, the hybrid display device 200 includes a color plate 210, a shutter device 220, and a diffuser 230.

The color plate 210 and the shutter device 220 are configured in the same manner as the color plate 110 and the shutter device 120 shown in FIG. 4. Hereinafter, overlapping descriptions will be omitted for clarity and conciseness.

The diffuser 230 is disposed between the color plate 210 and the shutter device 220. The diffuser 230 may diffuse and pass the color lights emitting from the sub color pixels SCP of the color pixels CP. The diffuser 230 may prevent or at least reduce the boundaries between the sub color pixels SCP and/or boundaries between the color pixels CP from being easily recognized when the color plate 210 generates color image, thereby reducing the effect on the final image of relatively low resolution of the sub color pixels SCP and/or the color pixels CP. The shutter device 220 may receive the diffused color lights through the diffuser 230.

The present invention is not limited to adding a diffuser 230. Varieties of optical elements may be inserted between the color plate and the shutter device in any combinations of kinds and numbers. In an embodiment, hybrid display device 200 includes an optical distance 240, which is a minimum gap between the color plate 210 and diffuser 230 for even diffusion of the color lights emitted by the color plate 210. Additional optical elements, such as micro-lenses or reflectors (not shown), may be disposed between color plate 210 and diffuser 230 to change light spread function (LSF) of color lights emitted by light-emitting diodes in underlying sub color pixels SCP. In certain embodiments, these additional optical elements would reduce the optical distance 240. Reduction of the optical distance 240 would thereby reduce thickness of the hybrid display device of the present disclosure.

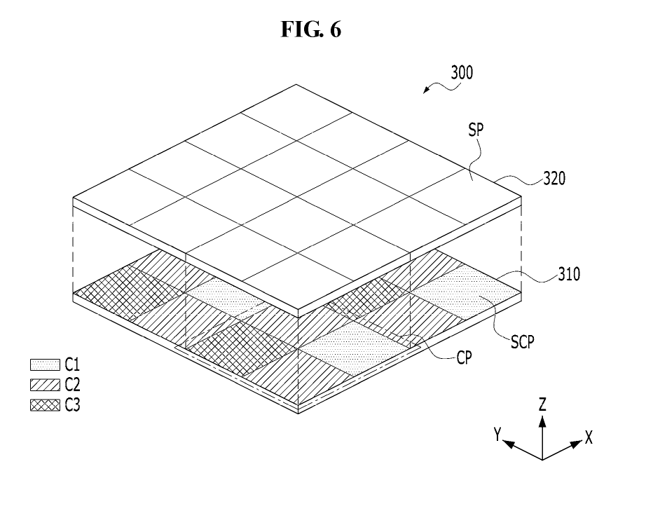

FIG. 6 is a perspective view of a portion of still another exemplary embodiment of a hybrid display device.

Referring to FIG. 6, the hybrid display device 300 includes a color plate 310 and a shutter device 320 disposed on the color plate 310. The color plate 310 may be configured in the same manner as the color plate 110 shown in FIG. 4. Therefore, redundant descriptions will be omitted for clarity and conciseness.

The shutter pixels SP may have a resolution equal to that of the sub color pixels SCP. Of course, the resolution of the shutter pixels SP is higher than that of the color pixels CP in this case. For example, each of the color pixels CP includes 4 sub color pixels SCP emitting a first color C1, a second color C2, a third color C3, and the second color C4, and 4 shutter pixels are provided for each of the color pixels CP.

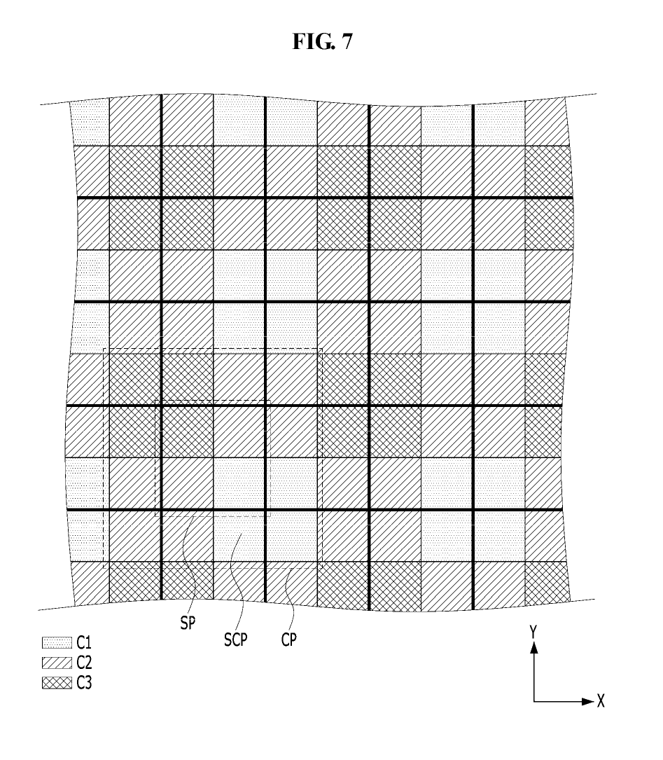

FIG. 7 is a plan view of a portion of yet still another exemplary embodiment of a hybrid display device.

The shutter pixels SP may be positioned on the color pixels CP in various ways. In an exemplary embodiment, the shutter pixels SP are positioned on the color pixels CP such that boundaries between the shutter pixels SP are positioned along boundaries between the sub color pixels SCP and each of the shutter pixels SP overlaps two or more sub color pixels SCP. As used in the present disclosure, references to structures of the shutter device being “positioned on” or “positioned along” structures of the color plate, and the term “overlap” and variants such as “overlapping”, refer to the geometric arrangement of these structures. In an exemplary embodiment, boundaries between the shutter pixels SP are positioned along boundaries between the sub color pixels SCP if a perpendicular plane substantially perpendicular to the color plate intersects both boundaries. As used in the present disclosure, a structure of the shutter device overlaps a structure of the color plate if the structure of the shutter device extends over at least a portion, and in some cases extends over substantially all, of the structure of the color plate. For example, in the embodiment of overlap shown in FIG. 6, each of the shutter pixels SP extends over substantially all of a sub color pixel SCP. In the embodiment of overlap shown in FIG. 7, each of the shutter pixels SP extends over a portion of each of 4 sub color pixels SCP. Given that each of the shutter pixels SP may control luminance of the color lights emitting from portions of the 4 sub color pixels SCP and therefore may control luminance of 4 colors in an area smaller than the color pixel, the color image output through the shutter pixels SP may have a resolution higher than that of the color pixels CP.

In another exemplary embodiment, as shown in FIGS. 4 and 6, the shutter pixels SP may be disposed on the color pixels CP such that at least some of boundaries between the shutter pixels SP are positioned along and overlap boundaries between the sub color pixels SCP as shown in FIGS. 4 and 6. In this case, each of the shutter pixels SP may overlap one sub color pixel and therefore may control luminance of the color light emitting from a corresponding sub color pixel.

For simplicity, the above discussions of shutter pixels SP controlling luminance of color lights emitted from one or more overlapping sub color pixels SCP assume there is no diffusion of the color lights emitted from the sub color pixels SCP before these lights are received by the shutter pixels. In the case of such diffusion, one or more additional shutter pixels SP, adjacent the shutter pixels that overlap the sub color pixels SCP, may control luminance of the diffused color lights.

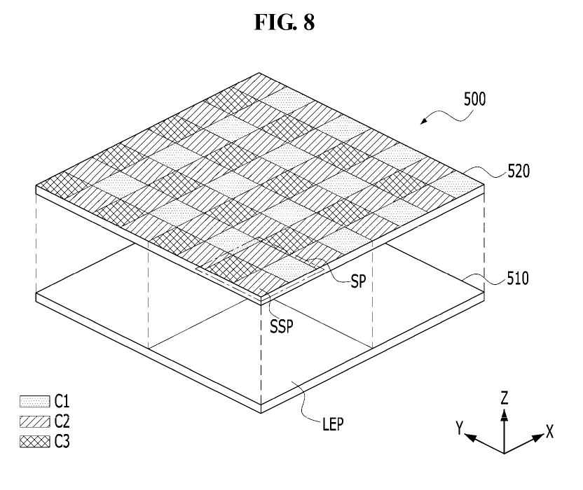

FIG. 8 is a perspective view of another exemplary embodiment of a hybrid display device constructed according to the principles of the invention.

Referring to FIG. 8, the hybrid display device 500 includes a lighting device 510 and a shutter device 520. The lighting device 510 includes a plurality of light-emitting pixels LEP emitting light to the shutter device 520. The light-emitting pixels LEP may emit the light of the same wavelength, such as white, ultraviolet ray, or blue. For instance, the light-emitting pixels LEP may include light-emitting diodes emitting the same color light.

The shutter device 520 includes a plurality of shutter pixels SP. The shutter pixels SP includes sub shutter pixels SSP each expressing one of color lights such as a first color C1, a second color C2, and a third color C3 by using the light from the light-emitting pixels LEP such that each of the shutter pixels SP generates various color lights. The first to third colors C1 to C3 may be red, green, and blue, respectively. The shutter device 520 may include the first substrate 121, the second substrate 122, and the liquid crystal layer 123 described with reference to FIG. 1, and may adjust the luminance of the lights emitting from the light-emitting pixels LEP. The shutter device 520 may further include color filters disposed in the second substrate 122 and overlapping the sub shutter pixels SSP, respectively. The color filters may convert the light from the light-emitting pixels LEP to predetermined wavelengths to display a color image.

The light-emitting pixels LEP each may be controlled to adjust the brightness of light. For instance, the brightness of each of the light-emitting pixels LEP may be controlled individually through signal lines coupled to a peripheral circuit of the hybrid display device 500. The lighting device 510 may include a thin-film transistor layer that has pixel circuits electrically connected to the peripheral circuit of the hybrid display device 500 via scan lines and data lines and configured to control the brightness of the light-emitting pixels LEP, respectively. In an embodiment, the pixel circuits to control the brightness of the light-emitting pixels LEP use an active matrix addressing scheme to switch individual light-emitting pixels LEP. In another embodiment, the pixel circuits to control the brightness of the light-emitting pixels LEP use an passive matrix addressing scheme. That is, the light-emitting pixels LEP of the lighting device 510 may emit the light and control the brightness of the light for each unit area, and the shutter pixels SP of the shutter device 520 may further adjust the luminance of the light as well as expressing the various colors. Thus, by providing the light-emitting pixels LEP able to control the brightness of the light for each unit area, the hybrid display device 500 may provide output images having relatively high resolutions.

The light-emitting pixels LEP may have a lower resolution than that of the sub shutter pixels SSP and the shutter pixels SP. The number of the light-emitting pixels LEP in a unit area may be less than that of the sub shutter pixels SSP and/or the shutter pixels SP. M number of the sub shutter pixels SSP and/or the shutter pixels SP may overlap one light-emitting pixel, where M is a positive integer equal to or greater than 1.

The input image data may be processed to generate first image data having a first resolution that corresponds to the light-emitting pixels LEP. The first image data may include luminance information of the input image data such that the peripheral circuit may drive the light-emitting pixels LEP based on the first image data. The input image data may also be processed to generate second image data having a second resolution that corresponds to the shutter pixels SP. The second image data may include color information of the input image data, and the peripheral circuit may drive the shutter pixels based on the second image data. Of course, the second image data may include luminance information of the input image data.

The light-emitting pixels LEP and the shutter pixels SP in the illustrated embodiment are shown as being arranged in the first and second directions X and Y. However, exemplary embodiments are not limited thereto. For example, the light-emitting pixels LEP and the shutter pixels SP may be arranged in one direction (e.g., the first direction X). For another example, the light-emitting pixels LEP and the shutter pixels SP may be arranged in a zigzag form.

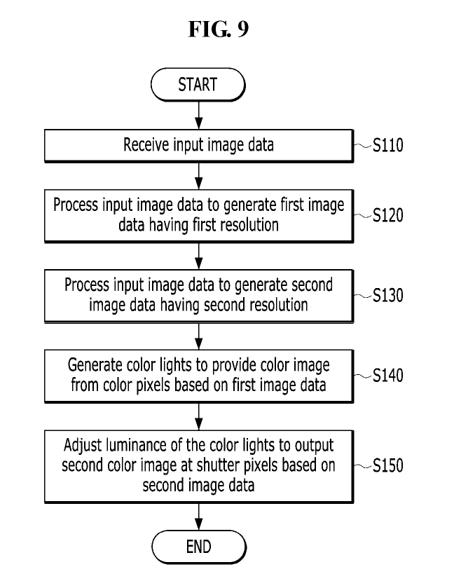

FIG. 9 is a flowchart of a method of generating a color image according to the principles of the invention.

Referring to FIGS. 1 and 9, at step S110, input image data is received. At step S120, the input image data is processed to generate first image data having a first resolution that may correspond to the resolution of color pixels CP. The first image data may include color information of the input image data such that a peripheral circuit associated with the color plate 110 may drive color pixels CP based on the color information. The first image data may further include luminance information of the input image data. In an exemplary embodiment, the peripheral circuit may perform the chroma subsampling on the input image data to generate the first image data having the first resolution when the input image data has a resolution higher than the resolution of the color pixels CP.

At step S130, the input image data is processed to generate second image data having a second resolution that may correspond to the resolution of shutter pixels SP. The second resolution is higher than the first resolution. The second image data may include luminance information of the input image data such that a peripheral circuit associated with the shutter device 120 may drive the shutter pixels SP based on the luminance information.

Steps S120 and S130 does not have to be processed in an order shown in FIG. 9. Steps S120 and S130 may happen in any orders. For example, step S130 may happen before S120, or steps S120 and S130 may happen at the same time.

At step S140, color lights are generated from the color pixels CP to provide a color image based on the first image data. The peripheral circuit associated with the color plate 110 may receive the first image data, and control sub color pixels of the color pixels CP to emit the color lights of the first color image based on the first image data.

At step S150, luminance of the color lights of the first image data is adjusted at the shutter pixels SP to output second color image based on the second image data. The peripheral circuit associated with the shutter device 120 may receive the second image data, and control the shutter pixels SP to output the second color image using the first color image. The shutter pixels SP have a higher resolution than the color pixels CP, and this may enable the second color image to be perceived by human being as having a higher resolution than the first color image. In an exemplary embodiment, the color lights of the first color image may be optically compensated before the luminance of the color lights of the first image data is adjusted. For example, the color lights of the first color image may be diffused by and pass through at least one diffusing layer such as a diffuser 230 described with reference to FIG. 5. Accordingly, the boundaries between the color pixels CP and/or the sub color pixels of the color pixels CP may be prevented or at least reduce from being easily recognized.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A display device, comprising:
a color plate comprising color pixels configured to emit color lights comprised in a first color image; and
a shutter device disposed on the color plate to receive the color lights of the first color image and comprising shutter pixels, wherein the shutter device is configured to adjust the color lights of the first color image to output a second color image,
wherein the shutter device contains a first number of the shutter pixels in a unit area and the color plate contains a second number of the color pixels in the unit area, the first number being greater than the second number.

2. The display device of claim 1, wherein the shutter pixels have a resolution higher than a resolution of the color pixels.

3. The display device of claim 1, wherein the color pixels comprises sub color pixels each emitting one of a plurality of colors.

4. The display device of claim 3, wherein in a unit area, the number of shutter pixels is equal to or greater than the number of sub color pixels.

5. The display device of claim 3, wherein at least some of boundaries between the shutter pixels are positioned along boundaries between the sub color pixels.

6. The display device of claim 5, wherein the at least some of boundaries between the shutter pixels overlap the sub color pixels.

7. The display device of claim 3, wherein each of at least some of the shutter pixels overlaps two or more sub color pixels.

8. The display device of claim 3, further comprising a first peripheral controller configured to control the sub color pixels to emit the color lights of the first color image based on first image data having a resolution of the color pixels.

9. The display device of claim 8, wherein the first peripheral controller is configured to receive second image data and to perform chroma subsampling on the second image data to provide the first image data when the second image data has a resolution higher than the resolution of the color pixels.

10. The display device of claim 1, further comprising a second peripheral controller configured to control the shutter pixels to adjust the luminance of the first color image based on second image data having the resolution of the shutter pixels.

11. The display device of claim 1, further comprising at least one diffusing layer disposed between the color plate and the shutter device and configured to diffuse and pass the color lights of the first color image.

12. The display device of claim 1, wherein:
the color pixels comprises sub color pixels each emitting one of a plurality of colors; and
the color plate comprises a substrate and light-emitting diodes arranged on the substrate, wherein the light-emitting diodes are included in the sub color pixels.

13. The display device of claim 1, wherein the color plate comprises a micro-LED display, and the shutter device comprises a liquid-crystal display.

14. A method of generating a color image, the method comprising steps of:
receiving input image data;
processing the input image data to generate first image data including color information of the input image data and to generate second image data including luminance information of the input image data, the first image data having a first resolution and the second image data having a second resolution higher than the first resolution;
generating color lights to provide a first color image based on the first image data; and
adjusting luminance of the color lights of the first color image to output a second color image based on the second image data.

15. The method of claim 14, wherein:
the step of generating comprises generating the color lights of the first color image from color pixels; and
the step of adjusting comprises adjusting the luminance of the color lights of the first color image at shutter pixels overlapping the color pixels to receive the color lights of the first color image.

16. The method of claim 15, further comprising the step of optically compensating the first color image to diffuse the first color image before adjusting the luminance of the first color image, wherein the step of adjusting comprises adjusting the luminance of the color lights of the optically compensated first color image at the shutter pixels overlapping the color pixels, and adjusting the luminance of the color lights of the optically compensated first color image at one or more shutter pixels adjacent the shutter pixels overlapping the color pixels.

17. The method of claim 15, wherein the first resolution corresponds to the number of the color pixels and the second resolution corresponds to the number of the shutter pixels.

18. The method of claim 14, wherein the input image data has a third resolution higher than the first resolution, and the step of processing comprises performing chroma sub sampling on the input image data to generate the first image data.

19. The method of claim 14, further comprising a step of optically compensating the first color image before adjusting the luminance of the first color image.

20. The method of claim 19, wherein the step of optically compensating comprises diffusing the color lights of the first color image before adjusting the luminance the first color image.
